(19) United States
(12) Patent Application Publication
(10) Pub. No.: US 2011/0250517 A1
(43) Pub. Date: Oct. 13, 2011

(54) GASEOUS FUEL SUPPLY SYSTEM FOR A FUEL CELL

(75) Inventors: Yen-Yu Chen, Kwei Shan Township (TW); Yi-Fan Wu, Kwei Shan Township (TW); Chi-Bin Wu, Kwei Shan Township (TW)

(73) Assignee: Chung-Hsin Electric and Machinery Manufacturing Corp., Jhonghe City (TW)

(21) Appl. No.: 12/787,416

(22) Filed: May 26, 2010

(30) Foreign Application Priority Data
Apr. 9, 2010 (TW) 099111174

(51) Int. Cl. H01M 8/04

(52) U.S. Cl. 429/442

(57) ABSTRACT

The present invention discloses a gaseous fuel supply system for a fuel cell. The gaseous fuel supply system includes a first valve, a filter element, at least one pressure adjusting element, a first pipeline, a second valve, a flow rate detector, and a check valve. The first valve makes connection to a gaseous fuel supply source, and the filter element makes connection to the outlet of the first valve. The pressure adjusting element controls the gas pressure of fuel gas. The first pipeline makes connection between the pressure adjusting element and the second valve. The flow rate detector and the check valve are made connection sequentially after the second valve. In virtue of the plural detectors used in the gaseous fuel supply source, once an abnormal phenomenon is detected, the first valve and the second valve will be turned off by a control unit to enhance the safety of the fuel cell.

### BACKGROUND OF THE INVENTION

1. Technical Field

The present invention relates to gaseous fuel supply system for a fuel cell, and more particularly, to a gaseous fuel supply system for enhancing the safety of the fuel cells.

2. Description of Related Art

With the increasing global energy consumption and raising environmental consciousness, the use of tradition energy sources becomes limited, and more attention has been put on the research of new energy sources. Since fuel cells are advantageous for having high efficiency and low pollution, the governments and businesses have shown their great interest in technologies related to fuel cells. For generating sufficient power, fuel cells have to be ensured with reaction efficiency, which highly depends on fuel.

In a fuel cell using fuel gas, a gaseous fuel supply system is typically implemented to supply the fuel to the fuel cell. However, for preventing fuel leakage that leads to failure of the fuel cell and danger, it is necessary to equip the gaseous fuel supply system with an effective and reliable protective mechanism.

FIG. 1 is a block diagram of a conventional gaseous fuel supply system 10. As shown in FIG. 1, the conventional gaseous fuel supply system 10 at least comprises a pressure adjusting element 11, a pressure detector 12 and a pipeline switch 13.

The gaseous fuel supply system 10 is provided between a gaseous fuel supply source 20 and a fuel cell 30, with a fuel pipeline 14 connecting the both. The pressure adjusting element 11 is settled between the fuel pipeline 14 and the gaseous fuel supply source 20 for adjusting the gas pressure from the gaseous fuel supply source 20 to one fitting the use of the fuel cell 30, so as to protect the fuel cell 30 from being internally damaged by excessive gas pressure. Furthermore, the pressure detector 12 serves to monitor the gas pressure inside the fuel pipeline 14 and according to the pressure detector 12, the pressure adjusting element 11 adjusts the gas pressure as described previously. The pipeline switch 13 is a switch for controlling the fuel pipeline 14 so as to allow or disallow the fuel to be supplied to the fuel cell 30.

However, in case of a breakdown or improper operation of the pipeline switch 13 that leads to excessive pressure, the conventional protective approach to the gaseous fuel supply system 10 would be too primitive to protect the fuel cell 30 from malfunction or damage or to avoid gaseous fuel leakage.

### SUMMARY OF THE INVENTION

The present invention relates to a gaseous fuel supply system for a fuel cell, which provides multiple protective mechanisms, so that when any of the protective mechanisms loses efficacy, the other protective mechanisms remain effective to protect the fuel cell, thereby securing the fuel cell from serious damage or safe concern.

The present invention relates to a gaseous fuel supply system for a fuel cell, which employs various detectors to monitor the gaseous fuel supply system in respects of pressure, temperature and flow rate, so as to prevent the fuel cell from damage and thereby ensure the overall system and the operational environment with safety.

To achieve the foregoing effects, the present invention provides a gaseous fuel supply system for a fuel cell, which is settled between a gaseous fuel supply source and the fuel cell. The gaseous fuel supply system comprises: a first valve whose inlet makes connection to the gaseous fuel supply source; a filter element whose inlet makes connection to an outlet of the first valve; at least one pressure adjusting element whose inlet makes connection to an outlet of the filter element; a first pipeline whose inlet makes connection to an outlet of the pressure adjusting element, wherein on the first pipeline, a pressure-releasing element, a pressure detector, a first gas detector and a first temperature detector are combined; a second valve whose inlet makes connection to an outlet of the first pipeline; a flow rate detector whose inlet makes connection to an outlet of the second valve; and a check valve whose inlet makes connection to an outlet of the flow rate detector and outlet makes connection to the fuel cell; wherein when any of the pressure detector, the first gas detector, the first temperature detector and the flow rate detector detects an abnormal phenomenon, a control unit turns off the first valve and the second valve.

By implementing the present invention, at least the following progressive effects can be achieved:

1. The multiple protective mechanisms are effective in not only improving the safety of the fuel cell, but also securing the fuel cell from serious damage.

2. The various detectors monitoring conditions of the gaseous fuel supply system enhance the safety of the fuel cell.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is a block diagram of a conventional gaseous fuel supply system;

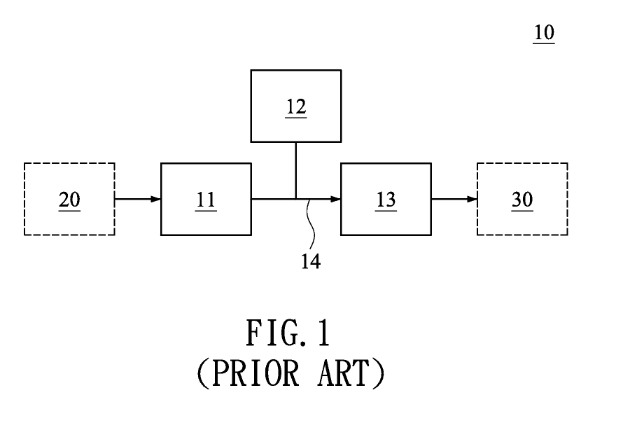

FIG. 2 is a block diagram of a gaseous fuel supply system for a fuel cell according to the present invention;

FIG. 3 is a first embodiment of a control structure of the gaseous fuel supply system of the present invention;

FIG. 4 is a second embodiment of a control structure of the gaseous fuel supply system of the present invention; and

FIG. 5 is a third embodiment of a control structure of the gaseous fuel supply system of the present invention.

### DETAILED DESCRIPTION OF THE INVENTION

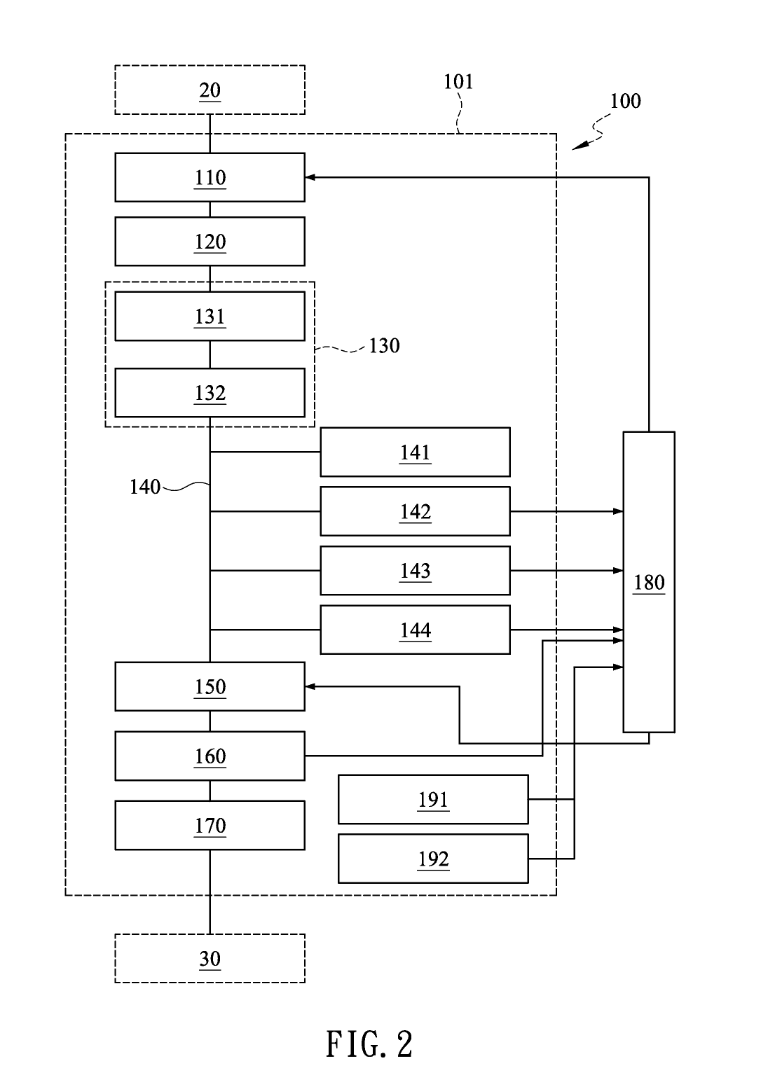

As shown in FIG. 2, the present embodiment is a gaseous fuel supply system 100 for a fuel cell 30. The gaseous fuel supply system 100 comprises a first valve 110, a filter element 120, at least one pressure adjusting element 130, a first pipeline 140, a second valve 150, a flow rate detector 160, a check valve 170 and a control unit 180. Therein, the gaseous fuel supply system 100 is settled between a gaseous fuel supply source 20 and the fuel cell 30 for supplying the gaseous fuel from the gaseous fuel supply source 20 to the fuel cell 30.

The first valve 110 is provided at an outlet of the gaseous fuel supply source 20 and has an inlet making connection to the gaseous fuel supply source 20 for allowing or disallowing the fuel to be supplied to the gaseous fuel supply system 100, wherein the first valve 110 may be a solenoid valve.

The filter element 120 has an inlet making connection to an outlet of the first valve 110 for filtering impurity from the fuel so as to prevent impurity particles from entering and damaging the fuel cell 30 or affecting normal function of the pressure adjusting element 130.

The pressure adjusting element 130 has an inlet making connection to an outlet of the filter element 120. Since the fuel gas released from the gaseous fuel supply source 20 has the gas pressure extremely high, it is necessary to adjust the gas pressure of the fuel by the pressure adjusting element 130. The pressure adjusting element 130 may be composed of a first pressure adjusting element 131 and a second pressure adjusting element 132. Therein, the first pressure adjusting element 131 may make connection to the filter element 120 for adjusting the gas pressure of the fuel filtered by the filter element 120. The second pressure adjusting element 132 may make connection to the first pressure adjusting element 131 for finely adjusting the gas pressure of the fuel as a protective mechanism buffering possible pressure surges.

The first pipeline 140 has an inlet making connection to an outlet of the second pressure adjusting element 132 and acts as the major fuel pipeline in the gaseous fuel supply system 100. Furthermore, for exactly detecting the pressure, temperature and composition of the fuel gas in the first pipeline 140, the first pipeline 140 may be further provided with a pressure-releasing element 141, a pressure detector 142, a first gas detector 143 and a first temperature detector 144.

Therein, the pressure-releasing element 141 may be a relief valve preset with a relief threshold so that when the gas pressure of the fuel goes beyond the relief threshold, the pressure-releasing element 141 operates to reduce the gas pressure to a value below the relief threshold, thereby preventing the abnormal pressure from damaging the first pipeline 140 and the fuel cell 30.

The pressure detector 142 serves to detect the pressure existing inside the first pipeline 140. When the detected pressure is excessively high, the pressure detector 142 directs the control unit 180 to turn off the first valve 110 and the second valve 150, so as to cut off the supply of the fuel gas.

The first gas detector 143 serves to detect monitoring the composition of the fuel in the first pipeline 140. For instance, the first gas detector 143 may monitor the concentration of carbon monoxide in the fuel gas. The first temperature detector 144 on the other hand monitors the temperature of the fuel in the first pipeline 140 to see whether it is over high or over low. Once the first gas detector 143 or the first temperature detector 144 detects any abnormal phenomenon related to the composition or temperature of the fuel gas in the first pipeline 140, it directs the control unit 180 to turn off the first valve 110 and the second valve 150, thereby cutting off the supply of the fuel gas.

The second valve 150 has an inlet making connection to an outlet of the first pipeline 140, and the second valve 150 may also be a solenoid valve. In the present embodiment, the first valve 110 and the second valve 150 are implemented together, wherein the first valve 110 controls the fuel to or not to flow into the gaseous fuel supply system 100 while the second valve 150 controls the fuel to or not to flow out of the gaseous fuel supply system 100 and be supplied to the fuel cell 30.

In virtue of the first valve 110 and the second valve 150, the supply of the fuel can be accurately controlled, and double protection is achieved. When one of the valves 110, 150 fails, the other valve 110 or 150 can still effectively control the supply of the fuel, thereby significantly enhancing the safety of the gaseous fuel supply system 100 in use.

The flow rate detector 160 has an inlet making connection to an outlet of the second valve 150 and serves to monitor the flow rate of the fuel in the first pipeline 140. Once the flow rate detector 160 detects any abnormal phenomenon related to the flow rate of the fuel, the flow rate detector 160 directs the control unit 180 to turn off the first valve 110 and the second valve 150, so as to timely cut off the supply of the fuel and in turn prevent the excessively high flow rate from otherwise causing malfunction or breakdown of the fuel cell 30.

The check valve 170 has an inlet making connection to an outlet of the flow rate detector 160 and has an outlet making connection to the fuel cell 30. The check valve 170 only allows the fuel to flow out of the gaseous fuel supply system 100 and prevents moisture as a product of the electrochemical reaction taking place in the fuel cell 30 from flowing back to the gaseous fuel supply system 100.

According to the above description, the present embodiment employs various detectors, including the pressure detector 142, the first gas detector 143, the first temperature detector 144 and the flow rate detector 160, as the protective mechanisms of the gaseous fuel supply system 100. Once any of the pressure detector 142, the first gas detector 143, the first temperature detector 144 and the flow rate detector 160 detects any abnormal phenomenon, the control unit 180 turns off the first valve 110 and the second valve 150 so as to timely cut off the supply of the fuel.

In addition to the foregoing detectors which monitor the conditions along the path of the fuel, a second gas detector 191 and a second temperature detector 192 may further be provided peripherally to the gaseous fuel supply system 100 for monitoring the peripheral conditions of the gaseous fuel supply system 100.

Therein, the second gas detector 191 serves to detect fuel leakage around the gaseous fuel supply system 100 by monitoring, for example, the concentration of carbon monoxide in the air. The second temperature detector 192 serves to monitor the ambient temperature of the gaseous fuel supply system 100. Once the second gas detector 191 or the second temperature detector 192 detects any abnormal phenomenon, the control unit 180 turns off the first valve 110 and the second valve 150, thereby cutting off the supply of the fuel.

Besides, referring to FIG. 2, the gaseous fuel supply system 100 may further have a casing 101 enclosing the first valve 110, the filter element 120, the pressure adjusting element 130, the first pipeline 140, the second valve 150, the flow rate detector 160 and the check valve 170 therein. The second gas detector 191 and the second temperature detector 192 may be settled in the casing 101 or outside the casing 101 (not shown).

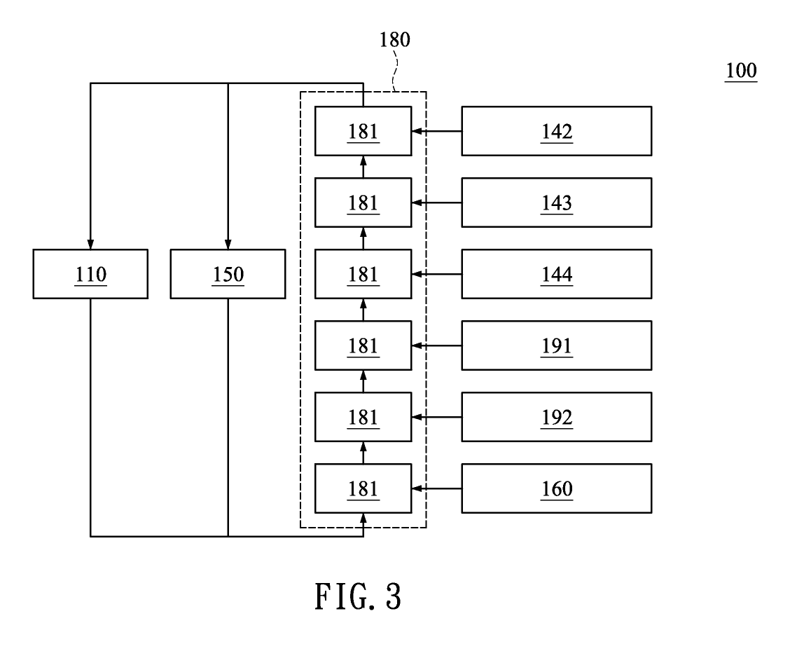

AS shown in FIG. 3, the control unit 180 may be composed of a plurality of relays 181 connected in series. Each of the relays 181 is independently activated by the pressure detector 142, the first gas detector 143, the first temperature detector 144, the second gas detector 191, the second temperature detector 192 and the flow rate detector 160 to operate.

Once any of the aforementioned detectors 142, 143, 144, 191, 192 and 160 detects an abnormal phenomenon, it triggers the relay 181 to operate accordingly, thereby turning off the first valve 110 and the second valve 150. In addition, each of the pressure detector 142, the first gas detector 143, the first temperature detector 144, the second gas detector 191, the second temperature detector 192 and the flow rate detector 160 may be associated with a gauge (not shown), respectively, for exhibiting the detected conditions.

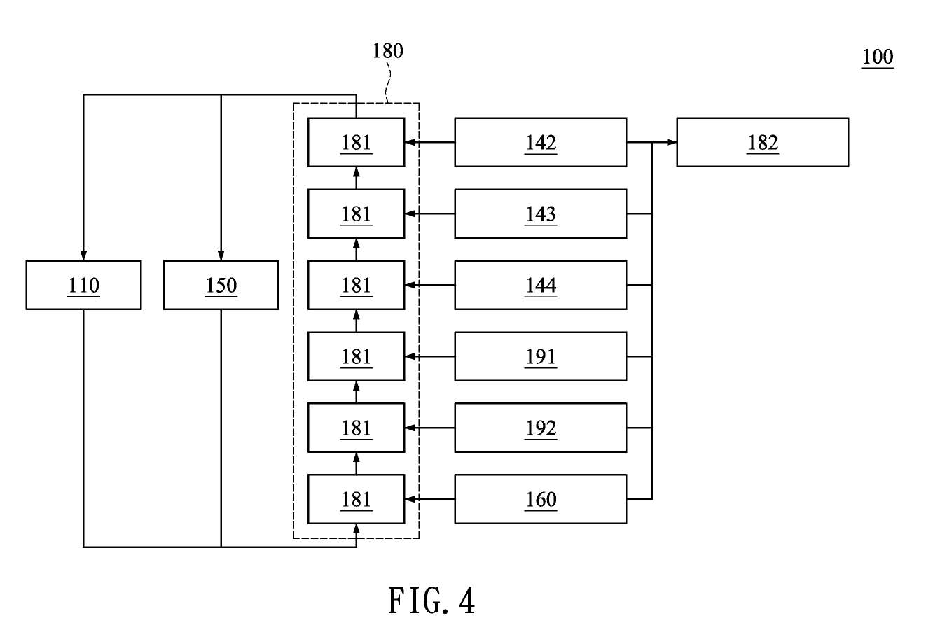

Referring to FIG. 4, the control unit 180 may further have a system controller 182, which includes a display interface to display the conditions detected by the pressure detector 142, the first gas detector 143, the first temperature detector 144, the second gas detector 191, the second temperature detector 192 and the flow rate detector 160, so as to allow a user to be clearly aware of why the first valve 110 and the second valve 150 are turned off.

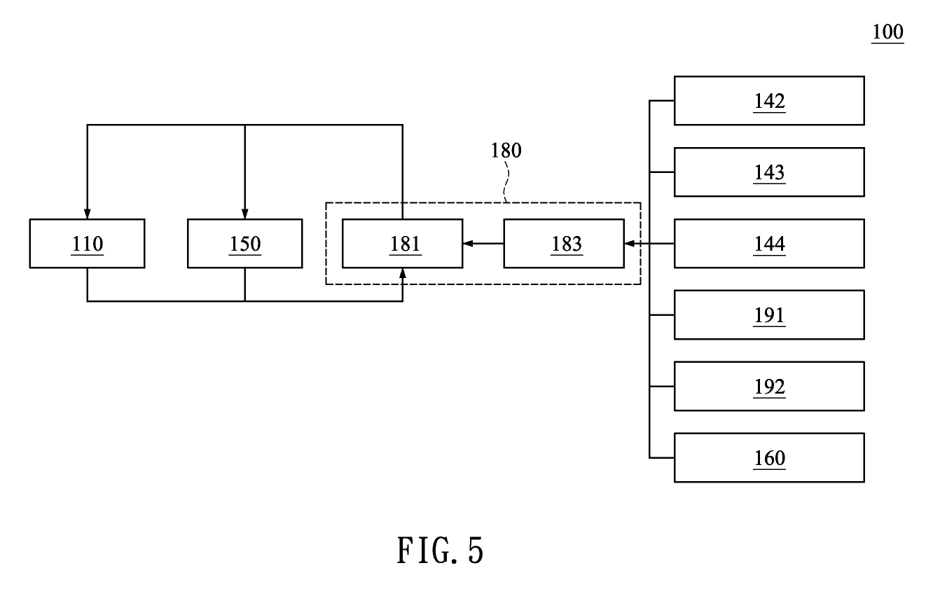

FIG. 5 shows an alternative structure of the control unit 180, wherein the control unit 180 has a magnetic element 183 and a relay 181. An input of the magnetic element 183 is configured to be activated by the pressure detector 142, the first gas detector 143, the first temperature detector 144, the second gas detector 191, the second temperature detector 192 and the flow rate detector 160 to operate. Once any of the detectors 142, 143, 144, 191, 192 and 160 detects an abnormal phenomenon, the magnetic element 183 is directed to operate and drive the relays 181 to turn off the first valve 110 and the second valve 150.

In virtue of the pressure detector 142, the first gas detector 143, the first temperature detector 144, the second gas detector 191, the second temperature detector 192 and the flow rate detector 160 as the multiple protective mechanisms of the gaseous fuel supply system 100, even when some of the protective mechanisms fail, the other protective mechanisms can still protect the fuel cell 30 from serious damage, and in turn ensure the safety of the overall system and the operational environment.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A gaseous fuel supply system for a fuel cell, which is settled between a gaseous fuel supply source and the fuel cell, the gaseous fuel supply system comprising:
a first valve having an inlet making connection to the gaseous fuel supply source;
a filter element having an inlet making connection to an outlet of the first valve;
at least one pressure adjusting element having an inlet making connection to an outlet of the filter element;
a first pipeline having an inlet making connection to an outlet of the pressure adjusting element, and having a pressure-releasing element, a pressure detector, a first gas detector and a first temperature detector combined thereon;
a second valve having an inlet making connection to an outlet of the first pipeline;
a flow rate detector having an inlet making connection to an outlet of the second valve; and
a check valve having an inlet making connection to an outlet of the flow rate detector, and having an outlet making connection to the fuel cell;
wherein when any of the pressure detector, the first gas detector, the first temperature detector and the flow rate detector detects an abnormal phenomenon, a control unit turns off the first valve and the second valve.

2. The gaseous fuel supply system of claim 1, further comprising a second gas detector peripherally provided thereto, wherein when the second gas detector detects an abnormal phenomenon, the control unit turns off the first valve and the second valve.

3. The gaseous fuel supply system of claim 1, further comprising a second temperature detector peripherally provided thereto, wherein when the second temperature detector detects an abnormal phenomenon, the control unit turns off the first valve and the second valve.

4. The gaseous fuel supply system of claim 1, further comprising a casing.

5. The gaseous fuel supply system of claim 4, further comprising a second gas detector settled in the casing and peripherally provided to the gaseous fuel supply system, wherein when the second gas detector detects an abnormal phenomenon, the control unit turns off the first valve and the second valve.

6. The gaseous fuel supply system of claim 4, further comprising a second temperature detector settled in the casing and peripherally provided to the gaseous fuel supply system, wherein when the second temperature detector detects an abnormal phenomenon, the control unit turns off the first valve and the second valve.

7. The gaseous fuel supply system of claim 1, wherein each of the first valve and the second valve is a solenoid valve.

8. The gaseous fuel supply system of claim 1, wherein the control unit comprises a plurality of relays connected in series, and each of the relays is configured to be activated by the pressure detector, the first gas detector, the first temperature detector and the flow rate detector, respectively, to operate.

9. The gaseous fuel supply system of claim 1, wherein the control unit has:
a magnetic element having an input configured to be activated by the pressure detector, the first gas detector, the first temperature detector and the flow rate detector, respectively, to operate the magnetic element; and
a relay driven by the magnetic element.
